(19) United States
(12) Patent Application Publication
(10) Pub. No.: US 2021/0229064 A1
(43) Pub. Date: Jul. 29, 2021

(54) BRANCHED POLYMER CROSS-LINKED GRAPHENE OXIDE ADSORBENT MATERIAL

(71) Applicant: DUKE UNIVERSITY, Durham, NC (US)

(72) Inventor: Nicholas GEITNER, Durham, NC (US)

(21) Appl. No.: 17/159,772

(22) Filed: Jan. 27, 2021

Related U.S. Application Data
(60) Provisional application No. 62/966,247, filed on Jan. 27, 2020.

(51) Int. Cl. B01J 20/02; B01J 20/26; B01J 20/30; C02F 1/28; C01B 32/198; C08K 5/405; C08K 5/132; C08K 5/07; C08L 79/02

(52) U.S. Cl. CPC B01J 20/02; B01J 20/267; B01J 20/3071; C02F 1/288; C01B 32/198; C08K 5/405; B82Y 30/00; C08K 5/07; C08L 79/02; B01J 2220/46; C02F 2305/08; C01P 2004/20; C08K 5/132

(57) ABSTRACT

A graphene oxide adsorbent material for filtering contaminants from water is formed of graphene oxide plates cross-linked by branched polymer nanoparticles.

### CROSS-REFERENCE TO RELATED APPLICATIONS

The present invention claims the benefit of U.S. Provisional Application Ser. No. 62/966,247, filed Jan. 27, 2020.

### STATEMENT REGARDING FEDERALLY SPONSORED RESEARCH

This invention was made with Government support under Federal Grant nos. EF-0830093 and DBI-1266252 awarded by the National Science Foundation. The Federal Government has certain rights to this invention.

### BACKGROUND

Availability of clean water is an ongoing and growing global challenge, exacerbated by climate change, increasing population, and pollution. To counter this new threat, new materials and technologies for water remediation have emerged. A variety of methods, including ion exchange, electrolysis, and sorption, have been applied to remove pollutants from aquatic ecosystems. Among these methods, sorption is one of the most promising techniques for water remediation due to its outstanding characteristics, such as cost-effectiveness, eco-friendliness, and fast performance.

### BRIEF SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure provides an adsorbent material, comprising, consisting of, or consisting essentially of graphene oxide plates cross-linked by branched polymer nanoparticles.

Another aspect of the present disclosure provides a method of removing contaminants from water using the disclosed adsorbent material.

### DETAILED DESCRIPTION

The accompanying Figures are provided by way of illustration and not by way of limitation. The foregoing aspects and other features of the disclosure are explained in the following description, taken in connection with the accompanying example figures (also “FIG.”) relating to one or more embodiments, in which:

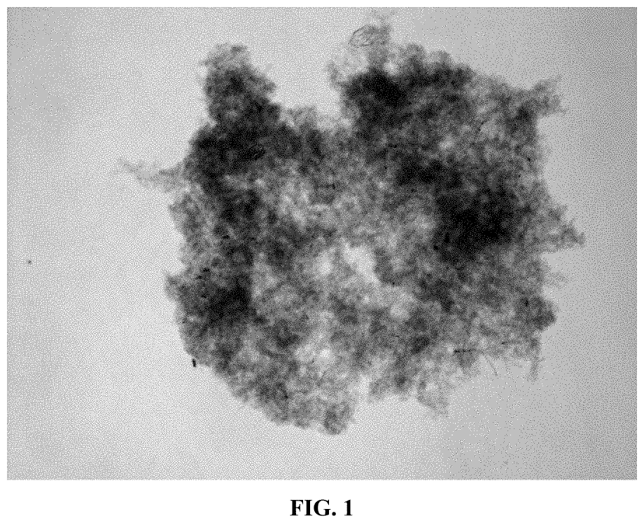

FIG. 1 is a photograph of a graphene oxide adsorbent material in accordance with one embodiment of the present disclosure;

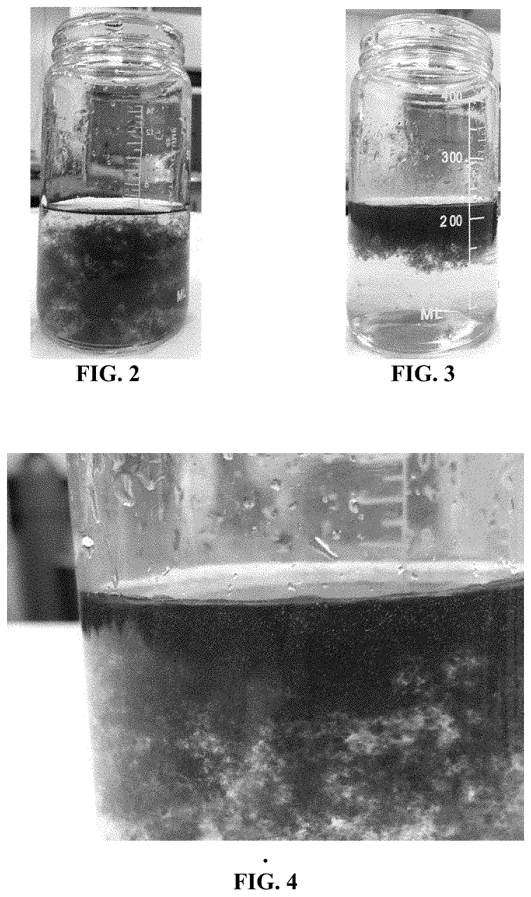

FIG. 2 is a photograph of a graphene oxide adsorbent material during synthesis process, after mixing;

FIG. 3 is a photograph of the graphene oxide adsorbent material of FIG. 2, after adding acetone;

FIG. 4 is a photograph showing a close-up image of the bubbles forming on the surface and throughout the sponge material after addition of acetone as shown in FIG. 3, confirming a successful reaction; and

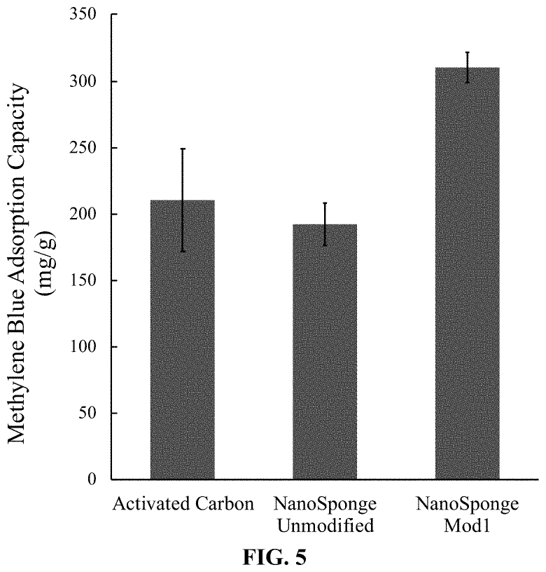

FIG. 5 shows a plot comparing adsorption capacity of activated carbon, unmodified sponge, and the described graphene oxide adsorbent material.

### DETAILED DESCRIPTION

Branched polymer cross-linked graphene oxide adsorbent material is provided. The described material can be used for water remediation, both in small scale systems and large scale systems.

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The material disclosed herein is a water contaminant adsorbent material, comprising graphene oxide plates cross-linked by branched polymer nanoparticles. Under the correct conditions, the branched polymer cross-linked graphene oxide self-assembles into macroscopic sponge-like architectures.

FIG. 1 is a photograph of a graphene oxide adsorbent material in accordance with one embodiment of the present disclosure. In particular, FIG. 1 is a microscope image of a graphene oxide adsorbent “sponge” with a width of several millimeters. To produce the disclosed adsorbent materials, single graphene oxide plates, which are suspended in water, are permanently cross-linked by branched amine polymers. This results in a macroscopic material several millimeters in diameter. The materials can be further modified by facile reactions with ketone groups at the remaining amine surfaces. The resulting sponge-like structure has a low fluid flow resistance and is highly water retentive.

According to various embodiments, synthesis can be optimized to minimize material waste and make synthesis as simple as possible in terms of the feasible dilutions of components. In an example implementation, the fabrication process for graphene oxide adsorbent sponges includes the following steps.

In step 1, the process includes preparing stock solutions of Graphene Oxide (GO, 0.2 g/L) and high molecular weight Branched Polyetheleneimine (bPEI, 1 g/L), both with pH adjusted to 7.0.

In step 2, the process includes combining the prepared solutions in a ratio of 10:1 GO:bPEI.

In step 3, the process includes mixing the combination. The mixing can be performed, ideally by vortexing or vigorous shaking (see e.g., FIG. 2 described below).

In step 4, the process includes adjusting the pH of the mixed combination to 5.5.

In step 5, the process includes adding acetone with weight approximately equal to the mass of bPEI used in synthesis (see e.g., FIGS. 3 and 4 described below).

These five steps result in a “base” material.

FIGS. 2-4 are photographs illustrating the synthesis process. FIG. 2 is a photograph of a graphene oxide adsorbent material during synthesis process, after mixing (e.g., step 3); FIG. 3 is a photograph of the graphene oxide adsorbent material of FIG. 2, after adding acetone (e.g., step 5); and FIG. 4 is a photograph showing a close-up image of the bubbles forming on the surface and throughout the sponge material after addition of acetone as shown in FIG. 3, confirming a successful reaction. As can be seen in FIG. 4, the formation of bubbles and material rising to the surface indicates successful reaction with the ketones.

In some implementations, the base graphene oxide adsorbent material can be customized. For example, for customization, some fraction of acetone can be replaced with other ketones containing the desired surface groups. The capping by the acetone (and/or other ketones) halts any further cross-linking reaction, and allows the material to be stored long term at neutral pH.

Indeed, after adding the acetone or acetone and other ketone(s) as described in step 5, step 6 can be carried out by separating synthesized material from water and rinsing the material with clean water. Step 6 may be carried out, for example, by decanting, simple filter paper, mesh screens, etc. The separated, rinsed material can then be collected and stored for future use. It should be understood that the remaining concentrated material with associated water should not be allowed to fully dry.

The above strategy of ketone-capping the material allows for long term storage and stability. Further, the ketones used in the above-described synthesis process may be removed and subsequently replaced with a ketone of choice by lowering the pH below 5, washing, raising pH to 5.5, and reacting with any fresh ketone.

The mechanism of cross-linking is an epoxy reaction; bPEI amine groups open the epoxide rings present at the surface of graphene oxide and form covalent bonds. The branched nature of bPEI allows this reaction with multiple graphene oxide plates, thus cross-linking them permanently. Advantages of this mechanism over others include the covalent nature of the linking, and the lack of any chemical pre-processing of the graphene oxide.

As can be seen, the primary amines in bPEI perform a ring opening epoxy reaction to covalently bind with the epoxide groups in the plane of graphene oxide. Functionalization for contaminant targeting happens at “leftover” primary amines on bPEI.

Customization of the sponge's surface chemistry by addition of different ketones allows one to target specific contaminants which may otherwise be poorly removed by conventional means. Indeed, it is possible to functionalize the bPEI cross-linker within the structure instead of having to functionalize the graphene oxide itself. Examples of materials for functionalization include any metal chelating agent that can be attached to an amine group. In some cases, a derivative of 2-pyridinecarboxaldehyde thiosemicarbazone (2-PTSC) can be used for removing Hg, 1,8-dihydroxyanthraquinone (DHAQ) can be used for removing Pb, long chain organic compounds can be used to facilitate binding with oily molecules, and multi-valent charged molecules can be used for removing ions (and even for ion exchange).

The disclosed adsorbent materials have several advantages over conventional filtration materials. First, they can have extremely high surface area per mass due to their nanoscale structure, far greater than commonly used activated charcoal and other filter materials. Also different from many other nanoparticle-based materials, their permanent cross linking also makes them large enough to settle out of solution in tanks or to be incorporated in filtration cartridges. Further, the combination of materials offers multiple modes of contaminant removal through physical and chemical processes. Such a wide range of mechanisms and capabilities are not offered by the most common current filtration methods. Moreover, additional functional groups present on the polymer cross-linkers provide potential attachment structure for additional ligands for targeted contaminant removal. The combination of these factors can allow significant advantages over traditional filters such as fiber filters or activated charcoal, such as the ability to remove a far wider range of contaminants, including typically challenging species for filtration such as lead, antibiotics, and pesticides.

In some embodiments, the disclosed adsorbent materials also provide opportunities to attach ligands capable of selectively removing elements of qualitative or scientific value from water. Ketone group customization allows for the removal of contaminants or concentration of valuable resources not possible by traditional filters or adsorbents. Some non-limiting examples include heavy metals, nutrients, small molecule toxins, and radio nucleotides. These ketone groups are also easily removed and replaced after use without destroying the framework material, and refreshed. They may also be added to the material in any combination, allowing for multi-functional customization.

Another advantage of the disclosed material is that the synthesis process can be achieved using a very low energy input, in contrast with conventional solutions, such as activated charcoal, which is thermally treated. Further, the open structure easily allows water to flow through in ambient conditions and is highly water retentive. This prevents the accidental drying issues faced by activated carbon filters.

In summary, the disclosed material is a low energy cost, customizable, adsorbent material capable of removing a wide variety of components from water.

Another embodiment of the present disclosure provides a method of treating water using the disclosed materials. As will be evident to a person of skill in the art, the adsorbent material can be deployed in a number of different ways. For example, it can be in the form of cartridges for home use in whole-home or under sink filtration, or in countertop consumer filtration systems. In other embodiments, it can be used by industrial companies in order to efficiently purify their high-volume wastewater streams in order to stay in environmental policy compliance. In another example, it may be used in large cartridges or settling tanks in municipal water treatment as a way to remove contaminants not well removed by most current methods, including disinfection byproducts and many small molecules such as pesticides and antibiotics.

Prototype Example

As illustrated in FIGS. 1-4, a graphene oxide adsorbent material was fabricated according to the synthesis method described above. X-Ray Diffraction (XRD) testing of the material, even dried, confirms a completely amorphous structure. This then confirms that the cross-linking of graphene oxide by bPEI successfully disrupted the stacked structure of the graphene oxide, also leaving voids between the plates for adsorption.

An adsorption benchmark test was carried out using methylene blue (MB) dye, a common standard in the industry. The capacity to adsorb this dye and remove the dye from water was carried out for two materials: the “base” material herein (“Unmodified”, acetone-capped), and a customized material capped with 50% acetone, 50% pyruvic acid (Mod1). These were compared with a range of values from peer-reviewed literature for commercial activated carbon. The results are shown in FIG. 5. FIG. 5 shows a plot comparing adsorption capacity of activated carbon, unmodified sponge, and the described graphene oxide adsorbent material. As reflected in the plot, the unmodified material matched the commercial-grade activated carbon in adsorption capacity, while the Mod1 material (capped with 50% acetone, 50% pyruvic acid) surpassed this capacity by approximately 50%. This is a clear demonstration that the material can also be customized to target specific contaminants for enhanced removal.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. An adsorbent material, comprising graphene oxide plates cross-linked by branched polymer nanoparticles.

2. The adsorbent material of claim 1, further comprising at least one functional group on cross-links of the branched polymer nanoparticles.

3. The adsorbent material of claim 2, wherein the at least one functional group comprises a metal chelating agent that is attachable to an amine group.

4. The adsorbent material of claim 2, wherein the at least one functional group comprises 2-pyridinecarboxaldehyde thiosemicarbazone (2-PTSC) or a derivative thereof.

5. The adsorbent material of claim 2, wherein the at least one functional group comprises 1,8-dihydroxyanthraquinone (DHAQ).

6. The adsorbent material of claim 2, wherein the at least one functional group comprises a long chain organic compound.

7. The adsorbent material of claim 2, wherein the at least one functional group comprises a multi-valent charged molecule.

8. A method of removing contaminants from water, comprising filtering the water through the adsorbent material of claim 1.

9. A method of fabricating an adsorbent material comprising:
preparing stock solutions of Graphene Oxide (GO, 0.2 g/L) and high molecular weight Branched Polyetheleneimine (bPEI, 1 g/L), both with pH adjusted to 7.0;
combining the prepared stock solutions in a ratio of 10:1 GO:bPEI into a combined solution;
mixing the combined solution;
adjusting the pH of the combined solution to 5.5 after mixing the combined solution;
adding at least one ketone to the combined solution after adjusting the pH to 5.5 to form a synthesized material in water; and
separating the synthesized material from the water and rinsing the separated synthesized material with clean water.

10. The method of claim 9, wherein mixing the combined solution comprises vortexing the combined solution.

11. The method of claim 9, wherein mixing the combined solution comprises vigorous shaking of the combined solution.

12. The method of claim 9, wherein adding the at least one ketone adds a combined weight of the at least one ketone approximately equal to the mass of the bPEI combined in the combined solution.

13. The method of claim 9, wherein the at least one ketone comprises acetone.

14. The method of claim 9, wherein the at least one ketone comprises acetone and a second ketone.

15. The method of claim 9, further comprising storing the separated synthesized material with associated water for a neutral pH.

16. The method of claim 9, wherein separating the synthesized material from the water comprises decanting.

17. The method of claim 9, wherein separating the synthesized material from the water comprises using a filter paper.

18. The method of claim 9, wherein separating the synthesized material from the water comprises using a mesh screen.

19. The method of claim 9, further comprising:
removing one or more of the at least one ketone from the synthesized material; and
replacing the removed one or more of the at least one ketone with a different ketone.

20. The method of claim 19, wherein the removing of the one or more of the at least one ketone and replacing the removed one or more of the at least one ketone with a different ketone comprises:
lowering the pH of a solution with the synthesized material below 5;
washing the synthesized material;
raising the pH of the washed synthesized material to 5.5; and
reacting with fresh ketone.
